(19) United States
(12) Patent Application Publication
(10) Pub. No.: US 2004/0124051 A1
(43) Pub. Date: Jul. 1, 2004

(54) Vehicle suspension damper having a bouyant sleeve for limiting rebound

(75) Inventors: Saiman Lun, Centerville, OH (US); Ilya Lisenker, Miamisburg, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/261,147

(22) Filed: Sep. 30, 2002

(51) Int. Cl. F16F 9/53

(52) U.S. Cl. 188/267.1

(57) ABSTRACT

A hydraulic vehicle damper is provided for limiting the extent and/or speed of extension of the damper on the rebound stroke with a variety of working fluids including magneto-rheological (MR) fluids, through the use of buoyant sleeve in the working chamber of the damper, rather than having rebound limiting elements attached to the damper piston or damper cylinder tube as in prior vehicle dampers.

### TECHNICAL FIELD OF THE INVENTION

This invention relates to a damper adapted for use in a vehicle suspension system, and more particularly to a hydraulic damper having a bouyant sleeve for limiting rebound.

### BACKGROUND OF THE INVENTION

Hydraulic dampers, such as shock absorbers and MacPherson struts have been used for many years in vehicle suspension systems for dissipating energy and reducing undesirable road inputs that would otherwise be transferred to the vehicle body and the associated passenger compartment.

Such dampers typically include a damper piston that is movable within a working chamber of a cylinder tube containing a hydraulic fluid and defining an axis of motion for the damper piston. The cylinder tube is attached to one part of the vehicle suspension, and includes a rod guide for guiding a piston rod connected to the damper piston. A piston rod extending from the damper piston, and out of the cylinder tube through the rod guide, is attached to another part of the vehicle suspension. As the parts of the vehicle suspension to which the cylinder tube and piston rod are attached move relative to one another, the damper piston is moved in compression and rebound strokes along the axis of the damper. The damper piston includes passages, and in some dampers also special valve arrangements associated with the passages, that allow fluid in the working chamber to flow through the damper piston at a controlled rate to provide damping of the relative motion between the parts of the vehicle suspension to which the damper is attached.

Some prior dampers have included a spacer and a resilient bumper fixedly attached to the damper piston or piston rod between the damper piston and the rod guide. The spacer and bumper contact the rod guide at the end of the rebound stroke for limiting the maximum extension of the damper during the rebound stroke. Fluid in the working chamber is caused to flow around the spacer, between the spacer and the inner wall of the cylindrical tube, as the damper piston and spacer reciprocate in the working chamber.

It has also been the practice in some prior hydraulic dampers to provide elements attached to the damper piston and the cylinder tube that provide additional hydraulic damping force acting against the piston during a portion of the rebound stroke, for slowing the damper piston as is approaches the end of the rebound stroke. This function of providing additional damping at the end of the rebound stroke, for slowing the rate of rebound, is also known as hydraulic “rebound cut-off” (RCO). Examples of this approach are disclosed in U.S. Pat. No. 6,209,691B1 to Fehring, et al, and U.S. Pat. No. 5,706,920 to Pees, et al, and in British patent 691,477 to Stephens.

In recent years, hydraulic dampers using a special type of fluid, known as Magneto-Rheological (MR) fluid, have been utilized as part of vehicle traction and stability enhancement control systems, for actively controlling the amount of damping provided under varying road and operating conditions, to provide improved performance and safe operation of vehicles. The MR fluid has microscopic particles of a magnetic material suspended in a liquid carrier. When the MR fluid is exposed to a magnetic field of sufficient strength, the suspended particles align with the magnetic field and cause a change in the viscosity of the MR fluid. As the viscosity of the MR fluid changes, the rate at which the MR fluid can flow through the flow passages in the damper piston also changed, thereby causing the amount of damping to be changed in a direct relationship to the viscosity of the MR fluid flowing through the flow damper piston.

Such MR dampers include electromagnetic coils in either the damper piston or the cylindrical tube for controlling the viscosity of the MR fluid. By controlling electrical current applied to the electromagnetic coil, the viscosity of the MR fluid within the flow passages in the damper piston can be changed to adjust the amount of damping provided to meet the operational requirements of the damper for various vehicle operating conditions, resulting in continuously variable real time damping. U.S. Pat. No. 5,277,281 to Carlson, et at, discloses a number of specific embodiments of MR dampers of the type described above.

MR fluids are generally significantly more viscous, and have a higher specific gravity, than the hydraulic fluids used in prior vehicle dampers including spacers attached to the damper piston and/or piston rod for limiting maximum extension or speed of extension of the damper on the rebound stroke, or elements for providing a hydraulic rebound cut-off function. As a result, the spacers and RCO elements used for limiting rebound in prior hydraulic dampers may provide inefficient and undesirable performance in dampers using MR fluids or other fluids having high viscosity and specific gravity. Also, MR fluids are significantly more expensive and heavier than the fluids used in conventional dampers, resulting in the cost or weight of the damper being undesirably high.

What is needed, therefore, is an improved hydraulic vehicle damper having elements for limiting maximum extension on rebound, and providing rebound cut-off, in a manner that allows efficient and effective use of MR fluids or other fluids having high viscosity and specific gravity. It is also advantageous to provide such an improved damper that reduces the volume of fluid required, and thereby the cost and weight of the fluid, particularly in a damper utilizing MR fluid.

### SUMMARY OF THE INVENTION

Our invention provides an improved hydraulic vehicle damper, that efficiently and effectively limits the extent and/or speed of extension of the damper on the rebound stroke with a variety of working fluids, including magneto-rheological (MR) fluids, through the use of buoyant sleeve in the working chamber of the damper, rather than having rebound limiting elements attached to the damper piston or damper cylinder tube as in prior vehicle dampers.

In one form of our invention, a vehicle damper includes a cylinder tube and a buoyant sleeve that functions as a spacer for limiting extension of the damper on the rebound stroke of the damper. The cylinder tube defines a working chamber extending along an axis, for containing a magneto-rheological (MR) fluid having a specific gravity therein. The cylinder tube also guides movement of a damper piston along the axis within the working chamber during a compression stroke and a rebound stroke of the vehicle damper. The buoyant sleeve has a specific gravity lower than the specific gravity of the MR fluid, and is floatably disposed within the working chamber, for resisting movement of the damper piston along the axis during a portion of the rebound stroke of the damper.

In another form of our invention, a suspension damper includes a cylinder tube, a rod guide, a damper piston, a piston rod, and a buoyant sleeve that functions as both a spacer and a rebound cut-off (RCO) piston. The cylinder tube defines a working chamber for containing a fluid therein and an axis. The rod guide closes one end of the cylinder tube, and is adapted for receiving and guiding a piston rod. The damper piston is slidably disposed in the working chamber for reciprocating motion along the axis. The piston rod has a first and a second end, with the first end connected to the damper piston for linear movement of the rod and damper piston within the working chamber along the axis, and with the second end of the piston rod extending along the axis, through the rod guide, and out of the working chamber. The buoyant sleeve has a central bore therein disposed about the piston rod between the damper piston and the rod guide for sliding motion of the buoyant sleeve along the piston rod.

A damper according to our invention may utilize MR fluids. The damper may include a spring disposed between the rod guide and the bouyant sleeve for holding the bouyant sleeve away from the rod guide. The cylinder tube and bouyant sleeve may be configured to define a passage for fluid to pass by the bouyant sleeve as the damper piston bears against the bouyant sleeve at the end of the rebound stroke, to thereby provide a hydraulic RCO function. The damper may include a seal and/or a bumper of elastomeric material disposed between the damper piston and the bouyant sleeve for precluding flow of fluid through the central bore of the bouyant sleeve during RCO operation. The bouyant sleeve may also have a closed construction that significantly reduces the volume of fluid required to fill the working chamber.

Our invention may also take the form of a method for limiting the extent and/or speed of extension of the damper on the rebound stroke, by attaching a buoyant sleeve having a central bore therein about the piston rod between the damper piston and the rod guide for sliding motion of the bouyant sleeve with respect to both the piston rod and the cylinder tube along the piston rod.

The foregoing and other features and advantages of our invention are apparent from the following detailed description of exemplary embodiments, read in conjunction with the accompanying drawings. The detailed description and drawings are merely illustrative of the invention rather than limiting, with the scope of the invention being defined by the appended claims and equivalents thereof.

### BRIEF DESCRIPTION OF THE DRAWINGS

FIG. 1 is a schematic cross-section of a first embodiment of a vehicle damper having a spacer in the form of a buoyant sleeve and a bumper, according to our invention; and

FIG. 2 is a schematic cross-section of a second embodiment of a vehicle damper having hydraulic rebound cut-off elements including a floatable rebound cut-off piston, in the form of a buoyant sleeve, and a spring for positioning the buoyant sleeve, according to our invention.

### DETAILED DESCRIPTION

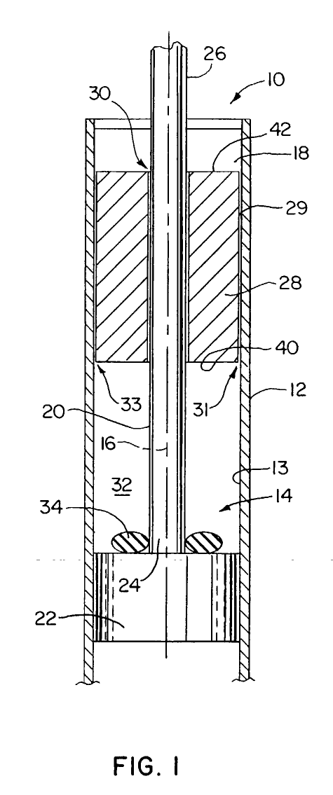

FIG. 1 depicts a first exemplary embodiment of a suspension damper 10, according to our invention, having a cylinder tube 12, defining a working chamber 14 for containing a fluid therein, and defining an axis 16. A rod guide 18 closes one end of the cylinder tube 12, and is adapted for receiving and guiding a piston rod 20, and for providing a sliding fluid seal between the piston rod 20 and the cylinder tube 12.

A damper piston 22 is slidably disposed in the working chamber 14 for reciprocating motion along the axis 16. The piston rod 20 has a first and a second end 24, 26. The first end 24 of the piston rod 20 is connected to the damper piston 22, for linear movement of the piston rod 20 and damper piston 22 within the working chamber 14, along the axis 16. The second end 26 of the piston rod 20 extends along the axis 16, through the rod guide 18, and out of the working chamber 14.

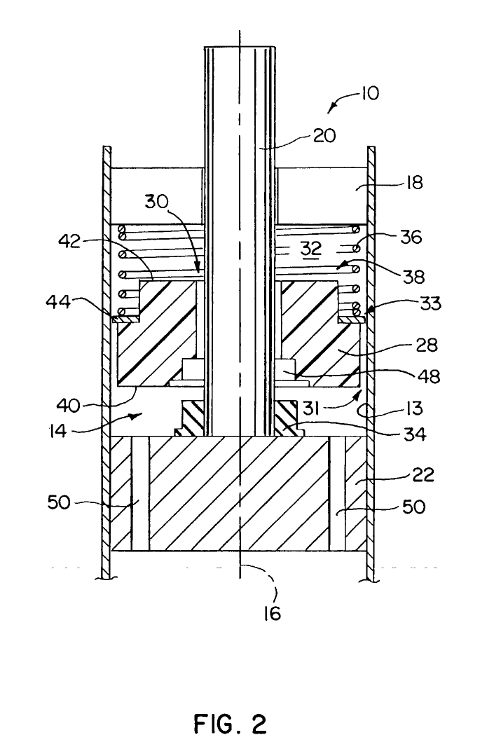

Those having skill in the art will recognize that the components described thus far in relation to relation to FIG. 1, and in the subsequent disclosure relating to FIG. 2, would include a number of features known in the art, such as fluid passages and valve components in the damper piston for example, that have been omitted from this explanation for clarity. We contemplate, however, that our invention may be practiced in forms incorporating such features known to those having skill in the art.

The damper 10 of FIG. 1 further includes a spacer, in the form of a buoyant sleeve 28, having a central bore 30 therein, disposed about the piston rod 20 between the damper piston 22 and the rod guide 18 for sliding motion of the bouyant sleeve 28 within the cylinder tube 12 and along the piston rod 22. The cylinder tube 12 defines an inner surface 13 thereof, and the bouyant sleeve 28 defines an outer surface 29 thereof, adjacent to the inner surface 13 of the cylinder tube 12 and spaced from the inner surface 13 of the cylinder tube 12 to form a gap 31 between the cylinder tube 12 and the bouyant sleeve 28. The gap 31 allows the bouyant sleeve 28 to move freely within the working chamber 14, and provides a passage 33 for fluid 32 to flow between the first and second ends 40,42 of the bouyant sleeve 28.

The working chamber 14 includes a volume of fluid 32 having a specific gravity. The bouyant sleeve 28 is configured in such a manner that the specific gravity of the bouyant sleeve 28 is less than less than the specific gravity of the fluid, so that the bouyant sleeve 28 floats in the fluid 32 at the top end of the working chamber 14 during normal operation of the damper 10.

In the first exemplary embodiment, shown in FIG. 1, the fluid 32 is a magneto-rheological (MR) fluid having a relatively high specific gravity in the range of 2.0 to 5.0. The bouyant sleeve 28 is fabricated as a solid annular cylinder of a plastic material, such as glass filled nylon, having a specific gravity in the range of 1.3 to 1.4. Such materials are robust enough to absorb the physical loads imposed on the bouyant sleeve 28 in arresting the motion of the damper piston 22, and light enough to float in the fluid 32. When our invention is practiced with other fluids 32, however, it may be desirable to utilize other materials for the bouyant sleeve 28, or include internal voids in the bouyant sleeve 28, so that the bouyant sleeve 28 will float in whatever fluid 32 is utilized in the working chamber 14.

A rebound bumper 34 of elastomeric material is attached to the damper piston 22, on the end of the damper piston 22 facing the bouyant sleeve 28, for providing additional cushioning when the damper piston 22 comes into contact with the bouyant sleeve 28 at the end of the rebound stroke.

Because the bouyant sleeve 28, in a damper 10 according to our invention, floats in the fluid 32 at the top of the working chamber 14, away from the damper piston 22, rather than having a spacer attached to the damper piston or piston rod as in prior dampers, the fluid 32 does not need to flow around the bouyant sleeve 28 during normal, i.e. non-maximum extension, of the damper 10. This allows the gap 31 between the bouyant sleeve 28 and the cylinder tube 12 to be smaller than would be the case in prior dampers, even when using highly viscous MR fluids. We contemplate that a typical gap 31 of 1 mm or less may be utilized.

Having a small gap 31 between the cylinder tube 12 and the bouyant sleeve 28 results in a tighter fit between the cylinder tube 12 and the bouyant sleeve 28, that is conducive to reducing operational noise of the damper 10, such as rattling of the bouyant sleeve 28 in the cylinder tube 12. Having the bouyant sleeve 28 float in the working chamber 14 away from the damping piston 22 also contributes to reducing operational noise.

In addition, the solid annular shape of the bouyant sleeve 28 displaces a considerable amount of fluid 32 without impacting performance of the damper 10, thereby reducing the volume of expensive MR fluid required for operating the damper 10. Reducing the volume of fluid in a damper utilizing MR fluid significantly reduces the overall mass and weight of the damper, particularly in dampers of large size. Dampers having lower mass and weight provide significant advantages in the design and operation of vehicle suspensions.

FIG. 2 shows a second embodiment of a suspension damper 10, according to our invention, including all of the elements described above in relation to the embodiment depicted in FIG. 1, and additional elements for utilizing a buoyant sleeve 28 as both a spacer and to provide a hydraulic RCO function, according to our invention.

The damper 10 of FIG. 2, includes a helical compression spring 36 disposed between the rod guide 18 and the bouyant sleeve 28 for holding the bouyant sleeve 28 away from the rod guide 18, and forming a small reservoir 38 of fluid 32 between the rod guide 18 and the bouyant sleeve 28. The bouyant sleeve 28 defines a first axial end 40 thereof facing the damper piston 22, a second axial end 42 thereof facing the rod guide 18, and in conjunction with the cylinder tube 12 defines a passage 33 for fluid flow between the first and second faces 40, 42 of the bouyant sleeve 28.

As was the case with the exemplary embodiment of FIG. 1, the cylinder tube 12 defines an inner surface 13 thereof, and the bouyant sleeve 28 defines an outer surface 29 thereof, adjacent to the inner surface 13 of the cylinder tube 12, and spaced from the inner surface 13 of the cylinder tube 12 to form a gap 31 between the cylinder tube 12 and the bouyant sleeve 28. The gap 31 defines a passage 33 for fluid to flow between the first and second ends 40, 42 of the bouyant sleeve 28 for filling and emptying the small reservoir 38.

In the embodiment of FIG. 2, however, the bouyant sleeve 28 includes an RCO disc 44 having an outer periphery 46 forming a portion of the outer surface 29 of the bouyant sleeve 28, and defining a generally annular shaped restriction in the fluid passage 33, in conjunction with the inner wall 13 of the cylindrical tube 12. The axial length and outer periphery of the RCO disc 44 can be closely controlled and matched to the inner wall 13 of the cylinder tube 12 to accurately and conveniently control the effective flow characteristics of the fluid passage 33, and facilitate tuning of the damper 10 to meet desired performance parameters for RCO operation.

The rebound bumper 34, in the embodiment of FIG. 2, also functions as a seal disposed between the damper piston 22 and the first end 40 of the bouyant sleeve 28, for resisting flow of fluid 32 through the central bore 30 of the bouyant sleeve 28 when the damper piston 22 is bearing against the bouyant sleeve 28. The bouyant sleeve 28 may include features, such as a counter bore 48 sized to receive the bumper 34, for enhancing the seal and preventing flow of the fluid 32 through the central bore 30 during RCO operation. Such additional features for improved sealing may be required to resist the relatively high pressures developed in the small reservoir 38 during RCO operation.

As was the case for the embodiment of FIG. 1, the material and configuration of the bouyant sleeve 28, and fluid 32, are selected to have respective specific gravities that result in the bouyant sleeve 28 being floatable in the fluid 32 at the upper end of the working chamber 14. The embodiment of FIG. 2 provides a hydraulic RCO function that is applicable to dampers using a wide variety of fluids, and in particular with MR fluids, with resulting advantages similar to those described above in regard to the embodiment of FIG. 1.

During normal, i.e. non-RCO, operation of the damper 10, the damper piston 22 is free to move independently from the bouyant sleeve 28 and its related components, as the piston rod 20 moves in and out of the cylinder tube 12 in response to the motion of the vehicle suspension. Fluid 32 in the working chamber 14 is forced through passages and valves in the damper piston 22, shown schematically as passages 50 in FIG. 2, as the damper piston 22 is moved by the piston rod 20 during normal operation of the damper 10.

As the damper 10 approaches a maximum extended position on the rebound stroke of the damper 10, the damper piston 22 is brought to bear against the bouyant sleeve 28. The rebound bumper/seal 34 enters the counter bore 48, and seals the central bore 30 in the bouyant sleeve 28.

Further motion of the damper piston 22 on the rebound stroke, after the damper piston 22 contacts the bouyant sleeve 28, forces the bouyant sleeve 28 to move upward, compressing the spring 36 and forcing fluid trapped above the bouyant sleeve 28 in the small reservoir 38 to flow through the passage 33 past the RCO disc 44 and bouyant sleeve 28 in a controlled manner that generates additional damping which resists and slows the damper piston 22, to thereby provide a hydraulic RCO function that reduces impact of the damping piston 22 against the rod guide 18 if the damping piston 22 continues to travel upward until the second end 42 of the bouyant sleeve 28 is brought into contact with the rod guide 18. Once the buoyant sleeve 28 is brought into contact with the rod guide 18, RCO operation ceases and the buoyant sleeve 28 functions as a spacer prevents further extension of the damper 10 during the rebound stroke.

Following RCO operation, the spring 36 forces the bouyant sleeve 28 away from the rod guide 18, as the damper piston 22 moves downward along the axis 16 on the compression stroke of the damper 10. As the bouyant sleeve 28 moves away from the rod guide 18, fluid 32 in the working chamber 14 flows through the passage 33 and past the bouyant sleeve to refill the small reservoir 38. Once the damper piston 22 has moved downward far enough to disengage the rebound bumper/seal 34 from the bouyant sleeve 28, additional fluid 32 flows through an annular space formed between the central bore 30 in the bouyant sleeve 28 and the piston rod 20, to more rapidly refill the small reservoir 38 and prepare the damper 10 for subsequent RCO operation.

While the embodiments of the invention disclosed herein are presently considered to be preferred, various changes and modifications can be made without departing from the spirit and scope of the invention. The scope of the invention is indicated in the appended claims, with all changes or modifications within the meaning and range of equivalents being embraced by the claims.

I claim:

1. A suspension damper comprising:
a cylinder tube defining a working chamber for containing a fluid therein and defining an axis;
a rod guide closing one end of the cylinder tube, adapted for receiving and guiding a piston rod;
a damper piston slidably disposed in the working chamber for reciprocating motion along the axis;
a piston rod having a first and a second end, the first end connected to the damper piston for linear movement of the rod and damper piston within the working chamber along the axis, the second end of the piston rod extending along the axis, through the rod guide, and out of the working chamber; and
a buoyant sleeve having a central bore therein disposed about the piston rod between the damper piston and the rod guide for sliding motion of the bouyant sleeve within the cylinder tube and along the piston rod.

2. The vehicle damper of claim 1 further comprising a fluid within the working chamber and wherein the bouyant sleeve is floatable in the fluid.

3. The vehicle damper of claim 2 wherein the fluid has a specific gravity, and the bouyant sleeve has a specific gravity that is less than less than the specific gravity of the fluid.

4. The vehicle damper of claim 2 wherein the fluid is a magneto-rheological (MR) fluid.

5. The vehicle damper of claim 4 wherein the (MR) fluid has a specific gravity, and the bouyant sleeve has a specific gravity that is less than less than the specific gravity of the (MR) fluid.

6. The vehicle damper of claim 1 further comprising a rebound bumper of elastomeric material disposed between the damper piston and the bouyant sleeve.

7. The vehicle damper of claim 1 further comprising a spring disposed between the rod guide and the bouyant sleeve for holding the bouyant sleeve away from the rod guide.

8. The vehicle damper of claim 1 wherein the bouyant sleeve defines:
a first axial end thereof facing the damper piston;
a second axial end thereof facing the rod guide; and
a passage for fluid flow between the first and second faces of the bouyant sleeve.

9. The vehicle damper of claim 8 wherein:
the cylinder tube defines an inner surface thereof; and
the bouyant sleeve defines an outer surface thereof adjacent to the inner surface of the cylinder tube and spaced from the inner surface of the cylinder tube to form a gap between the cylinder tube and the bouyant sleeve, the gap defining the passage for fluid between the first and second ends of the bouyant sleeve.

10. The vehicle damper of claim 9 wherein the bouyant sleeve includes an RCO disc having an outer periphery forming the outer surface of the bouyant sleeve, and defining the fluid passage in conjunction with the inner wall of the cylindrical tube.

11. The vehicle damper of claim 10 including a seal disposed between the damper piston and the first end of the bouyant sleeve for resisting flow of fluid through the central bore of the bouyant sleeve when the damper piston is bearing against the bouyant sleeve.

12. The vehicle damper of claim 11 further comprising a fluid within the working chamber and wherein the bouyant sleeve is floatable on the fluid.

13. The vehicle damper of claim 11 wherein the fluid is a magneto-rheological (MR) fluid having a specific gravity, and the bouyant sleeve has a specific gravity that is less than less than the specific gravity of the (MR) fluid.

14. The vehicle damper of claim 11 wherein the seal comprises a rebound bumper of elastomeric material disposed between the damper piston and the bouyant sleeve.

15. The vehicle damper of claim 11 further comprising a spring disposed between the rod guide and the bouyant sleeve for holding the bouyant sleeve away from the rod guide.

16. The vehicle damper of claim 15 wherein the spring and the passage formed by the bouyant sleeve provide a hydraulic rebound cut-off function, as the damper piston bears against the bouyant sleeve, by causing fluid residing between the bouyant sleeve and the rod guide to flow through the passage as the damper piston is forced against the bouyant sleeve by relative motion of the cylinder tube and piston rod in opposite directions along the axis.

17. A method for operating a vehicle damper having a cylinder tube defining a working chamber for containing a fluid therein and an axis, a rod guide closing one end of the cylinder tube for receiving and guiding a piston rod, a damper piston slidably disposed in the working chamber for reciprocating motion along the axis, and a piston rod having a first and a second end, the first end connected to the damper piston for linear movement of the rod and damper piston within the working chamber along the axis, the second end of the piston rod extending along the axis, through the rod guide, and out of the working chamber, the method comprising:
attaching a buoyant sleeve having a central bore therein about the piston rod between the damper piston and the rod guide for sliding motion of the bouyant sleeve with respect to both the piston rod and the cylinder tube along the piston rod.

18. The method of claim 17 wherein the bouyant sleeve has a specific gravity, the method further comprising:
introducing a fluid having a specific gravity greater than the specific gravity of the bouyant sleeve into the working chamber of the vehicle damper, so that the bouyant sleeve floats in the fluid.

19. The method of claim 18 further comprising:
attaching a spring between the bouyant sleeve and the rod guide for holding the bouyant sleeve away from the rod guide when the bouyant sleeve is floating in the fluid.

20. A vehicle damper comprising:
a cylinder tube defining a working chamber extending along an axis for containing a magneto-rheological (MR) fluid having a specific gravity therein and for guiding a damper piston for movement along the axis within the working chamber during a compression stroke and a rebound stroke of the vehicle damper; and
a buoyant sleeve having a specific gravity lower than the specific gravity of the MR fluid floatably disposed within the working chamber for resisting movement of the damper piston along the axis during a portion of the rebound stroke of the damper.
